(19) United States
(12) Patent Application Publication
(10) Pub. No.: US 2003/0048792 A1
(43) Pub. Date: Mar. 13, 2003

(54) Forwarding device for communication networks

(75) Inventors: Mao Xu, Overland Park, KS (US); Yihong Guo, Cupertino, CA (US)

Correspondence Address: Bo-In Lin, 13445 Mandoli Drive, Los Altos Hills, CA, 94022, US

(73) Assignee: QQ Technology, Inc.

(21) Appl. No.: 10/236,290

(22) Filed: Sep. 4, 2002

Related U.S. Application Data
(60) Provisional application No. 60/317,420, filed on Sep. 4, 2001.

(51) Int. Cl. H04L 12/28

(52) U.S. Cl. 370/400; 370/419

(57) ABSTRACT

The present invention discloses a generic design for the next generation of integrated backbone networks that process traffic from various services such as ATM, IP, FR, MPLS. The network devices possess high capacity (fully redundant) at least 80 Gbps, which focus on high-speed forwarding with protocol agnostic. The present invention includes switching architecture design, enhancement of combined input-output queuing mechanisms, and soft- and hard-scheduling algorithms. By emphasizing the overall systemic optimization and practical implementation, the present invention provides the designated switching system maximum throughput, minimum delay, and QoS guarantees.

This Application claims a priority date of Sep. 4, 2001 benefited from a previously filed Provisional Patent Application 60/317,420 filed on Sep. 4, 2001 by the Applicants of this Formal Patent Application.

### BACKGROUND OF THE INVENTION

1. Field of the Invention

This invention relates generally to communication networks. More particularly, this invention is related to networking devices that perform high-speed traffic forwarding, have scaleable high capacity, and support various levels of quality-of-service (QoS) for multiple protocols such as Asynchronous Transfer Mode (ATM), Internet Protocol (IP), Frame Relay, Multiple Protocol Labeling Switch (MPLS), over the same network.

2. Description of the Prior Art

While the Internet has quietly served as a research and education vehicle for more than two decades, the last few years have witnessed its tremendous growth and its great potential for providing a wide variety of services. Recently, the Internet has been growing at a very high rate. The number of hosts on the Internet has doubled approximately every 56 weeks since 1989, and the number of Web servers has doubled at least every 23 for the last three years. Because the Internet is growing at an exponential rate and as common access line speeds increase, the Internet requires a switching/routing capability of many gigabits per second of aggregate traffic. A forecast of the peak-hour bandwidth for the Internet traffic in the United States of America alone is expected to increase to 1000 Gbps in the year 2001 and 1,879 Gbps in 2002.

In addition, the bandwidth- and service-on-demand in local access networks are becoming more and more significant. Integration of various service solutions are necessary to meet the “last mile” requirement such that a one-stop-shopping solution is required to provide cost effective implementation for satisfying ever increasing demands for high bandwidth with quality of service (QoS). One example is that an integrated access device (IAD), which is located in a customer premise, provides legacy services, e.g., voice, data and value-added services, e.g., QoS IP.

The existing network switching and routing devices normally have capacity less than 40G and are limited to single technology oriented application, e.g., ATM or Frame Relay or native IP, in separated and dedicated networks. Consequently, the conventional switching and routing devices cannot be conveniently designed to be architecturally scaleable up to terabit as required in the near future. As a result, current network infrastructures will become a bottleneck between access and emerging optical networking. Furthermore, such limitations will also cause the service providers to repeatedly make high price system upgrades with diminished improvements in quality of services.

A typical next generation network infrastructure includes various legacy services and value-added services and these services are integrated to a single Core. The Core devices as described in the “Technology Forecast: 2000” by Price-Water-House-Coopers Technology Center as a system situated at the center of the network to perform high-speed forwarding. Coupled with the tremendous physical growth, the technical trends, are the diversity of the services that a communication system is required to perform. In particular, there is a great demand for high bandwidth signal transmission capable of providing quality-of-service (QoS) for a wide range of service integration. Hence, there is an urgent need for the design of scaleable and high-speed switches/routers that can provide QoS guarantees. However, traditional architectures of Internet routers have inherent limitations that hinder a design of routers to achieve the performance requirements suitable for operation in a high-speed environment. Furthermore, compared to recent development of high-speed switches, existing routers are expensive, unable to provide QoS guarantees, and can only provide limited throughput. In order to overcome these limitations, there is a trend in building high-speed integrated switch routers on top of fast packet switches such as the asynchronous transfer mode (ATM)-like switches to take the advantages of scalability and QoS guarantee capabilities. With this trend of developments, devices that are compatible with achievable line-rate throughput, scalable capacity with non-blocking, and low computational complexity are in demand to meet such development requirements.

Even that most state-of-the-art switches use non-blocking switching fabrics the switch scalability and achievable performances are still limited as these performances are affected by the queuing schemes and scheduling algorithms implemented in the conventional systems. Specifically, queuing schemes provide ways to buffer the incoming packets and are the main factor affecting switch scalabilities. On the other hand, scheduling algorithms guarantee predictable switches performances e.g., QoS guarantees including throughput, packet delay, jitters, and loss. While non-blocking switching fabric assures that only external conflicts can occur at the input or output ports of the switch and the external conflicts occurs at the input or output ports. Particularly, an external conflict occurs at input or output port when more than one cell need transmit signal in a time slot to the same input or output. The assurance of no conflicts within a switching fabric is often not sufficient to provide a total solution to the limitations and difficulties encountered by those of ordinary skill in the art in designing and configuring the communication networks. Improved schemes and algorithms are still required to resolve the external conflicts occurring at the input or output ports in addition to the internal conflicts occurring only in the blocking switching fabric. More specifically, there is still a need of an improved scheduling and algorithm methodology for implementation in a switch to resolve the input and output ports conflicts whenever the conflicts may occur.

A general model of an M×N switch, where M≧N, includes M input port controllers (IPCs), N output controllers (OPCs), interconnected by an interconnecting network (IN). Each input/output link is assumed to transmit data signals at the same speed. Without loss of generality, the input/output link speed is supposed to be one packet per time slot. If the IN operates at a speed of S times each input/output link, it is said that the switch has an internal speedup of S. Therefore, in each time slot, an IN with internal speedup S is capable of switching up to S packets from each IPC and to each OPC, respectively. More specifically, a switch with internal speedup S means that the switch performs scheduling and transmission of the queuing packets S times per a time slot. In other words, a time slot is further split into S mini-slots, and each mini-slot is the time interval of performing one scheduling and transmission of queued packets.

Within a switching router device, traffic forwarding performance is predominantly determined by the major components of switch fabric architecture, the queuing mechanisms and scheduling algorithms. Even though the state-of-the-art switching fabric architectures, such as crossbar, are inherently non-blocking, the actual performance is also dependent upon scheduling and queuing. For example, at speed of 80 Gigabits or higher, blocking or congestion at the device-level can occur even with non-blocking switch fabrics. Based on publicly available information, there is no equipment or design that can simultaneously satisfy stringent requirements of QoS and line-rate throughput. Our overall goal is provide a set of designs and design principles, focusing on the three components above that practically meet all these performance requirements to the maximum extent possible.

Queuing schemes provide ways to buffer the incoming packets and are the main factor affecting switch scalabilities. On the other hand, scheduling algorithms guarantee predictable switches performances e.g., QoS guarantees including throughput, packet delay, jitters, and loss. While non-blocking switching fabric assures that only external conflicts can occur at the input or output ports of the switch and the external conflicts occurs at the input or output ports. Particularly, an external conflict occurs at input or output port when more than one cell need transmit signal in a time slot to the same input or output. The assurance of no conflicts within a switching fabric is often not sufficient to provide a total solution to the limitations and difficulties encountered by those of ordinary skill in the art in designing and configuring the communication networks. Improved schemes and algorithms are still required to resolve the external conflicts occurring at the input or output ports in addition to the internal conflicts occurring only in the blocking switching fabric. More specifically, there is still a need of an improved scheduling and algorithm methodology for implementation in a switch to resolve the input and output ports conflicts whenever the conflicts may occur.

Because of the unscheduled nature of packet arrivals to a switch, more than one packet may simultaneously arrive at different input ports and be destined for the same output ports. With a speedup of one, the switch may allow only one of these contending packets to be immediately routed to the destined output port, but the others must be queued for transmission thereafter. This form of congestion is unavoidable in a packet switch, and dealing with it often represents the greatest source of complexity in the switch architecture. A plethora of proposals for identifying suitable architectures for high-speed switches/routers have appeared in the literature. These design proposals are based on various types of queuing strategies: output queuing, centralized shared queuing, input queuing, virtual output queuing, or combined input-output queuing.

Output Oueuing (OQ): When a packet arrives at an input port, it is immediately put into the buffer that resides at the corresponding output port. Because packets destined for the same output port may arrive simultaneously from many input ports, the output buffer needs capacity to accommodate traffic at a much higher rate. That may be M times higher in the worst case, where M is the number of input ports than a single port to remove a packet from the buffer. These considerations impose stringent limits on the size of a switching device.

Centralized Shared Queuing (CSQ): There is a single buffer shared by all the switch input ports, which can be viewed as a shared memory unit with M concurrent write accesses by the M input ports and up to N concurrent read accesses by the output ports. Because packets destined for the same output port may arrive simultaneously from many input ports, the output port needs to read traffic at a much higher rate than a single input port may write it, which places stringent limits on switch size.

Input Queuing (IQ): Input queuing does not have the scaling limitations of OQ or CSQ. In this architecture, each input port maintains a first-in first-out (FIFO) queue packets, and only the first packet in the queue is eligible for transmission during a given time slot. Regardless of its structure” simplicity, FIFO input-queued switches suffer from a performance bottleneck, namely head-of-line (HOL) blocking, which limits the throughput of each input port to a maximum of 58.6 percent under uniform random traffic, and much lower than that for bursty traffic. In particular, it has been shown that for exponential packet lengths and Poisson arrivals, the saturation throughput is only 0.5.

Virtual Output Queue (VOQ): This queuing scheme overcomes the HOL blocking associated with FIFO input queuing while keeping its scalability advantage. In this technique, each input port maintains a separated queue for each output port. One key factor in achieving high performance using VOQ switches is the scheduling algorithm, which is responsible for the selection of packets to be transmitted in each time unit from the input ports to the output ports. Several algorithms, such as parallel iterative matching (PIM), iSLIP, and RPA have been proposed in the literature. It was shown that with as few as four iterations of the above iterative scheduling algorithms, the throughput of the switch exceeds 99 percents. As a result, this switch architecture is receiving a lot of attention from the research community, and many commercial and experimental switches based on this queuing technique have already been built such as the Tiny-Tera switches and Cisco's 12000 series GSR routers.

Combined Input-Output Queuing (CIOQ): This queuing scheme is a combination of input and output queuing. It is a good compromise between the performance and scalability of both OQ and IQ switches. For input-queued switches, at most one packet can be delivered to an output port in one unit of time. For an output-queued switch, up to M packets can be delivered to an output port in one unit of time. Using CIOQ, instead of choosing these two extreme choices, one can choose a reasonable value in between. This can accomplished by having buffers at both the input and output ports.

In general, each of above approaches has some disadvantages. The IQ and OQ, approaches have a performance bottleneck and such bottlenecks do not affect other approaches. As the results established for the VOQ switches are also applicable to the CIOQ switches, and the VOQ and CIOQ approaches have greatly potential to achieve performances comparable to IQ and OQ switches, these approaches still have the following fundamental constraints:

Only one cell from any of the N queues (VOQ) in an input port can be transmitted in each time slot.

Only one cell can be transmitted from the M input ports to an output port at any given time slot. In other words, at most one cell could be received at a single output port.

Therefore, a scheduling algorithm that decides which inputs transmit their queued cells to which outputs for each time slot is of paramount importance. In other words, for providing QoS guarantees in a VOQ/CIOQ switch is to design a scheduling algorithm that can guarantee that queued packets are transmitted across the switch fabric promptly. If the control of the delays of queuing packets can be guaranteed, then the scheduling algorithm will definitively not lead to “starvation” for queued packets at any port.

There has been considerable research on developing scheduling policies that can provide QoS guarantees and designing scalable high-speed switches. Generally, the proposed scheduling policies can be classified into three categories according to the matching algorithms used to match inputs and outputs in each time slot. These categories are 1) algorithms based on time slot assignment (TSA), 2) algorithms based on maximal matching (MM). And, 3) algorithms that are based on stable matching (SM). The performance of these algorithms in terms of time complexity, maximum achievable throughput, and capability of supporting traffic with differential QoS will be compared in following table with the performance of the present invention as that listed in Table 1. However, as will be further explained in the descriptions of this invention, very little has been actually implemented using the QoS scheduling policies on scalable high-speed switches such as VOQ or CIOQ. Consequently, given the poor scalability of these switches, these research efforts have very little practical value with respect to high-speed switches with various QoS guarantees.

Additionally, even though some proposed algorithms can improve the time complexities with uniform traffic or both uniform and non-uniform traffic, the main disadvantage of these algorithms is that a time complexity (e.g., O(N^{2 5}) ) is required in each time slot. Due to these reasons, the techniques discussed above are not practically implemented due to the high degrees of complexities especially doe high-speed and high scaleable environments.

In short, with the speed of an input/output port normalized by the internal speedup S, the algorithms based on time slot assignment using maximum matching can achieve a highest (normalized) throughput as high as 100 percent. However, even with these algorithms, the scheduling of the queuing packets in a unique fashion is still not able to achieve a required differential QoS to individual traffic streams. There is still a need to provide a solution to resolve this problem. It is a critical objective to provide new algorithms to achieve these goals such that a person of ordinary skill in the art would be able to achieve the target of providing QoS for traffic in VOQ/CIOQ switches.

### SUMMARY OF THE PRESENT INVENTION

It is therefore the object of the present invention to advance the art by providing both soft- and hard-scheduling algorithms executed at packet-level by combining distributed and centralized scheduling processes. Better performance is achieved in environments where traffic is bursty or frequently changing with various QoS requirements because the scheduling processes are performed not only at connection-level as that performed by conventional algorithms based on time slot assignment. The designated scheduling algorithms as disclosed in this invention have time complexities substantially smaller than the ones based on maximum matching.

The associated queuing mechanism, in terms of enhanced CIOQ-strategy, is comprised of two-dimensional virtual output queues (VOQ) and virtual input queue (VIQ) that are configured in multi-stage. The queue(s) in each stage are correlated but independently perform different functions, such that minimize the overall systematic (from input to output) delay and jitters.

The non-blocking switching fabric is architecturally designed to provide inertial-speeding 2 (i.e., S=2) feature with two forwarded messages in a time slot follow the same arbitrating decision rather than each forwarded message corresponds to an identical arbitrating decisions. By taking consideration of available hardware environment, e. g., memory read/write speed, and the processing delay as well as load balancing this design is optimized. As a result, the target of 100 percent throughput is achievable.

A major object of the present invention is to provide a new service integrated transparent switching (SITS) design for a Core switching router that is protocol agnostic implemented with QoS guarantees. Therefore, with the new SITS design and implementation, the aforementioned difficulties and limitations in the prior arts can be overcome.

The other objective of the present invention is to clarify the boundaries of the switching system, with respect to comprehensive performance such as delay, loss and throughput, being subject to real restrictions (e.g., memory read/write processing speed) and unpredictable traffic behaviors (e.g., bursty with various CoS′ (ToS′)/QoS′). The strictly derived boundaries can be used as guidelines for service providers in network design and planning/provisioning, also for vendors in product design and delivery.

An additional object of the present invention is to provide designs and design principles that give clear and definable operational boundaries of the switching system, with respect to comprehensive performance such as delay, loss and throughput, being subject to implementation restrictions (e.g., memory read/write processing speed) and unpredictable actual traffic patterns (e.g., bursty with various CoS′ (ToS′)/QoS′). The strictly derived boundaries can be used as guidelines by service providers in network design, planning, and provisioning, as well as by vendors in product design and delivery.

Briefly, the present invention discloses effective solutions and optimal designs for a switching router by implementations of scaleable switching architecture with improved combined-input-and-output queuing mechanisms, and soft- and hard-scheduling algorithms. This invention provides an optimal design that simultaneously satisfies the performance requirements described above. The invention illustrated in this patent with examples of embodiments more particularly in the context of a core switching routers. Nevertheless, the design and the associated design principles are also applicable to edge devices.

### BRIEF DESCRIPTION OF THE DRAWINGS

FIG. 1 is a typical next generation networking infrastructure;

FIG. 2 is a functional block diagram showing the architecture of a next generation switching router;

FIG. 3 is a functional block diagram of a service independent transparent switching design of this invention; and

FIG. 4 is functional block diagram for showing service integration transparent switching control flow for the integrated switching router of this invention.

### DETAILED DESCRIPTION OF THE PREFERRED EMBODIMENT

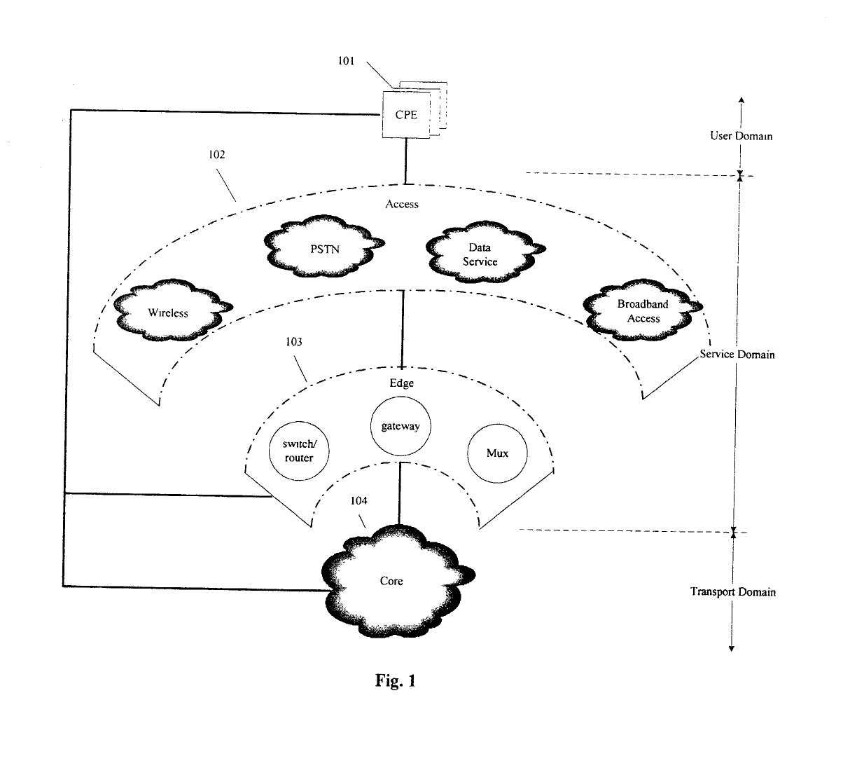

FIG. 1 depicts a typical next generation networking infrastructure. The network infrastructure includes a CPE 101 comprises integrated access devices (IADs) and/or legacy telecommunication device(s). The CPE 101 could be high-end group (HEG), e.g., a corporate office, or a low-end group, e.g., a branch office or a SOHO, a residential node, or wireless service stations. Where the communication paths could bypass access network 102 and directly to edge 103 or core 104 for some HEG users. An access network 102 in communication paths that could be collocated in a central office in metropolitan area or a point of presence (PoP). The access network 102 comprises a set of service-and technology-based local and/or metropolitan area networks (LANs/MANs), and tier nodes of legacy networks. The legacy networks could be a PSTN network (public switching telephone network), an IP/ISP backbone (native IP traffic only), a frame relay network, etc. An edge cluster 103 in communication with the access network comprises gateways, multiplexers, and switches/routers. The edge cluster 103 serves the functions of service integration/translation, broadband traffic aggregation. A core network 104 that can be a wide area network, i.e., a WAN-based network, is connected to the edge cluster 103 to perform high-speed traffic forwarding with protocol agnostic in terms of Layer2/3 switching and routing. Based on the functionality, the network infrastructure is partitioned into three domains: user domain that is user manageable (including requests of service- and bandwidth-on-demand); service domain that makes various delivered service assurance; transport domain that is separated from services providing high-speed transport and meeting the needs of SLAs. As explained above, the forwarding design for the integrated switching routers as describing in this Application can be used for both cores and edge devices. Particular emphasis is given to core applications as illustrated in the following embodiment, however, these examples should not diminish the significance of the invention is equally well when implemented in Edge applications.

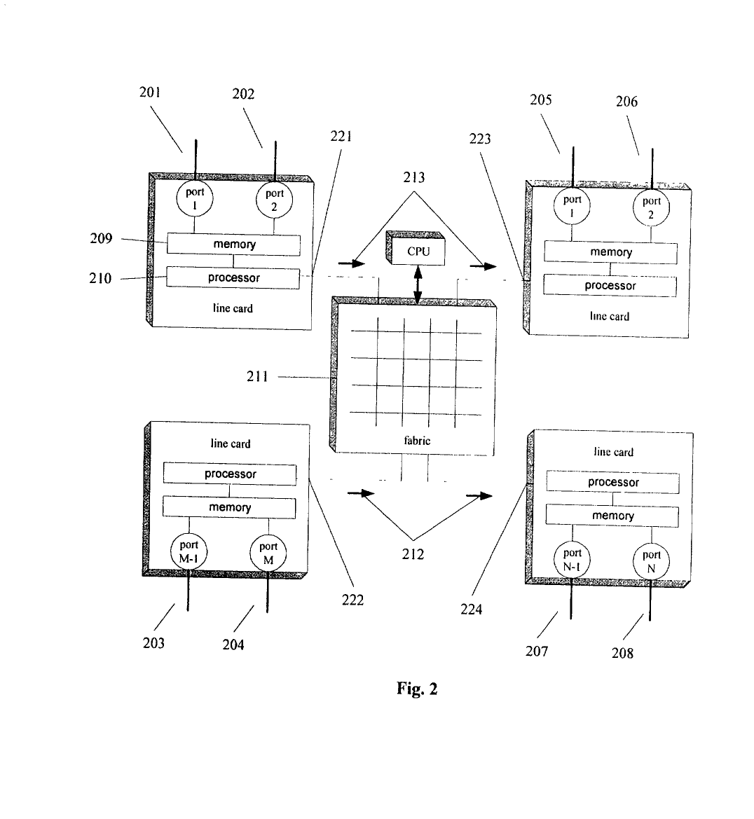

FIG. 2 depicts a functional block diagram showing the architecture of a next generation switching router of this invention in terms of switching and forwarding. In the center the fabric (211) is a crossbar switch connecting the input and the output line cards and replacing the conventional shared bus structure and allowing multiple packets (212, 213) to be simultaneously switched between ingress line-card interfaces (221, 222) and egress line-card interfaces (223, 224). A line card also includes a memory (209) that may include a set of chips such as a set of SRAM/SDRAM memory chips and the memory can also be shared within the line card depending on the designated purpose and needs. The processor 210 reside in the line card is provided mainly as ASICs (application-specific integrated circuits) oriented. The ASICs allows the designated logic implemented in hardware such that eliminates the potential bottleneck of the operational performance. As an example, to perform table lookup for traffic filtering and classifying, incoming packet/cell labels can form a direct pointer to a table entry with ASIC rather than relying on a sequential search through a table. switching technology and performing at “wire speed,”, i.e.,, the full speed of the transmission media on all ports. In most current designs, the ports (201, 202, 203, 204, 205, 206, 207, 208) can be configured as Giga-Ethernet and the diversity between OC-12 (625 Mbps) and OC-192 (10 Gbps) up to OC-768 (40 Gbps) in the near future. Due to unpredictable natures of aggregated traffic, the performance of the switching and the forwarding is a critical issue. For example, port 201 has 2 requests for port 205 and port 206 respectively, and port 204 has a request for port 206 in the same switching time slot. If a decision is made to permit port 201's request on port 206, then 2 requests have to wait in the queues while port 205 is idle in the time slot that results the throughput is lower. This is well known matching problem. Another example is that all pots 201, 202, 203, and 204 have requests on port 205. To handle this scenario known as congestion, policy-based decision must be made mainly based on QoS requirements, such as absolute priority, weighted priority, discarded priority. Since such decisions must be made within very short and limited time period (e.g., less than 51.2 ns to transmit 64-byte at 10 Gbps speed), to perform “wire speed” transmission with QoS guarantees is a big challenge.

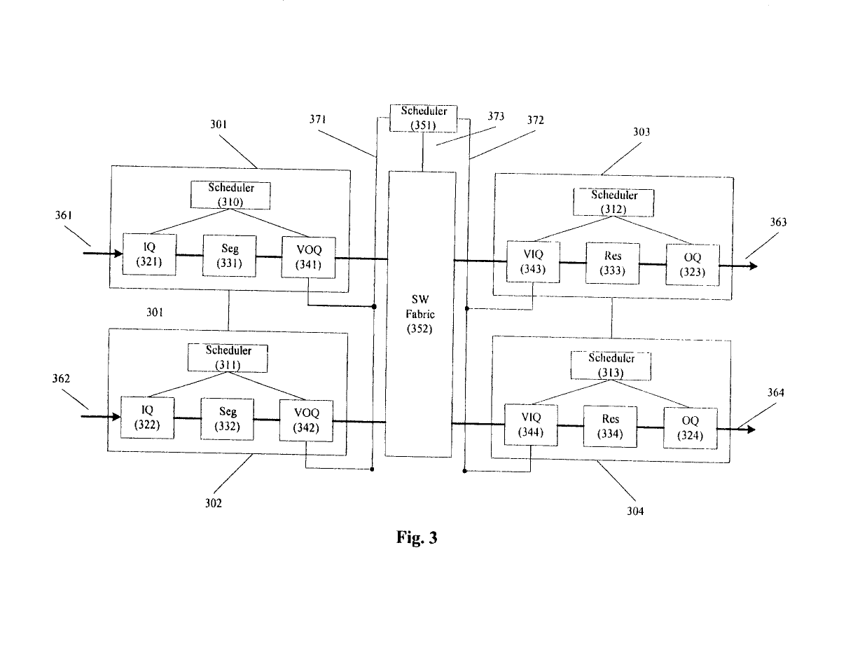

For the purpose of satisfying the performance requirement for a next generation network as that shown in FIG. 2, a Service Independence Transparent Switching (SITS) design for an integrated switch router is provided. The SITS is applied in terms of both optimal switching architecture and queuing/scheduling algorithms. The design targets to support various protocols traffic by focusing on QoS guarantees with achieving the maximum throughput theoretical and statistically. Advantageously, SITS is mainly comprised of schedulers that, in both distributed (per line card) and centralized (per switching fabric) manners, perform packet dispatching from ingress ports to egress ports according to CoS/ToS on a per flow basis, and packet forwarding from egress ports to the network according to QoS′. The SITS building block is shown in FIG. 3. Specifically, the “Service Independence” means that the coming packet flows, which could be ATM cells, IP/MPLS packets or frames, would be classified by designated input queuing algorithm(s) in support of achieving the maximum throughput (100% line rate). In order to achieve such purpose, all traffic will be encapsulated into designated cells (different from ATM cells) with fixed length and sent to the fabrics in terms of “Transparent Switching”. The Transparent Switching means that all traffic is fit into designated frames with fixed length so that the timing of the switching required by the scheduling is deterministically minimal and controllable. Advantageously, SITS is mainly comprised of schedulers that, in both distributed (per line card) and centralized (per switching fabric) manners. The SITS performs the packet queuing and dispatching from ingress ports to egress ports according to CoS/ToS on a per flow basis, and packet forwarding from egress ports to the network according to QoS′. Specifically, when bandwidth is aggregated and services are classified at the Edge as shown in FIG. 1, traffic flows are through the ingress ports of the line cards (FIG. 2). After associated Layer 2/3 switching/routing processing, traffic flows are ready for forwarding from ingress ports to egress ports (and to the network) that is functionally performed by SITS. The SITS building block is shown in FIG. 3.

The input traffic flow (361, 362) is currently considered up to 10 Gbps, which could be from either a single OC-192 port or aggregated from multiple lower rate ports (e.g., 16 OC-12 ports, or 4 OC-48 ports). In order to effectively manage and support QoS, the traffic over any ingress port shall be admissible, that is, the provisioning on core devices is not allowed over-subscription, while the practical over-subscription shall be applied for edge devices. The input queuing (IQ) mechanisms (321, 322) are on per egress port (as shown in FIG. 2) basis, where the queues (321, 322) are constructed based on three groups in terms of priorities used by the scheduler (310, 311). Note that in order to perform L2/L3 switching and routing such as table lookups for ATM VPI/VCI translation, a singe first-in-first-out (FIFO) buffering (not a queue) on per port basis is required. The FIFO buffering is not shown in FIG. 3 as it is not used and managed in the design field. Indicated by CoS′/ToS′ attributes, traffic flows with both delay and loss requirements or loss requirement only will be filtered into the queues with high-priority (H-group) and mid-priority (M-group) respectively. Otherwise, traffic flow will be queued with low priority (L-group). Each group has an identical VOQ that is on per egress line card basis. That is, let N and k be the number of egress line card and egress ports (k>N) respectively, the total number of IQs is 3 k and the total number of VOQ is 3N. All incoming traffic, regardless, will be segmented (331, 332) into frames with fixed length, and enqueued in VOQ (341, 242) for being dequeued by the scheduler (351). The decisions of scheduling and routing for switching fabric 352 are sent through communication paths (371, 372, 373). The VIQ (343, 344) is virtual input queue in which incoming frames are buffered for re-assembling (333, 334). Let N also be the number of ingress line cards, then there are 3N VIQs on a egress line card. The final stage is the output queuing (OQ) mechanisms (323, 324) on per egress port basis, in which traffic reassembled in original packets/cells is de-queued by schedulers (312, 313) based on known QoS′.

Rather than per port queuing, our VOQ, and VIQ are on per line-card basis with CoS/ToS priorities. This design is not only making relative processes (e.g., scheduling) simpler, but also dramatically increasing the switching scalability with desired QoS guarantees. Because of proven effective scheduling algorithms, the sizes of VOQ and VIQ are small in few frames such that can be implemented in cache of embedded ASICs. Since, on the other hand, the approaches of distributed computation and parallel processing are combined in the overall designs, the operational latency between input and output is minimized so that the traffic forwarding speed can achieve the maximum line rate. Therefore, the architecture as an improved two-stage CIOQ is achieved. With the queuing and scheduling processes discussed above, the constraints as that encountered in the prior art have been relaxed. The first constraint that only one cell from any of the N queues (VOQ) in an input port can be transmitted in each time slot can be removed with switching fabric that has a speedup S>1. The second constraint of the prior art that only one cell can be transmitted from the M input ports to an output port at any given time slot is also resolved with the innovative queuing and scheduling processes disclosed in this invention.

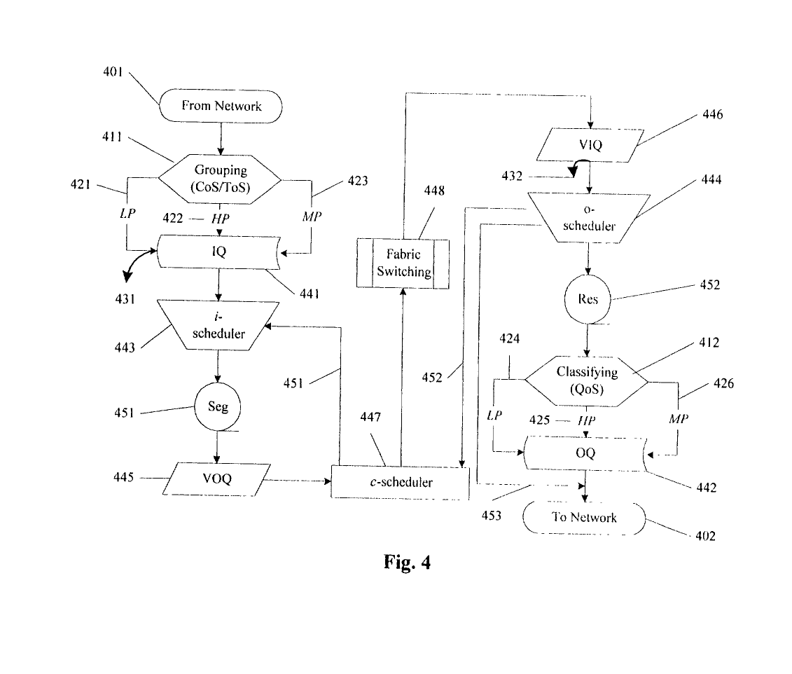

Referring to FIG. 4 for the processing flow of the queuing and the scheduling in the designated architecture. In FIG. 4, a traffic flow is coming from network (401), where the traffic could be parallel or series flow. The input data stream is filtered into 3 groups: low-priority (LP, 421), mid-priority (MP, 423), and high-priority (HP, 422) by the grouping (411) that is a component of scheduler 301, and enqueued in input queue (IQ) 441. Simultaneously, the i-scheduler (443), another component of the scheduler 301, dequeues packets/cells from IQ to be sequentially segmented (451) into frames. Frames are then momentarily buffered in VOQ (445), and dispatched by c-scheduler (447, the same as 351) through the switching fabric (448). Along with the scheduling decisions, the non-blocking routing paths across the fabric are also determined by the centralized scheduler (447). Frames are again buffered in VIQ (446) until all frames that can consist of a complete packet/cell are determined arriving, and those frames are sent by o-scheduler (444) to reassemble (452). While the o-scheduler is mutually operating with frame buffering (VIQ), frames that belong to the same packet will dropped (432) when one of them is detected wrong. The reassembled packet/cell is classified according to the three group (HP, MP, and LP), enqueued in the output queue (OQ, 442), and dequeued (o-scheduler 444, 453) based on QoS′ to the network (402).

When OQ (442) reaches predetermined thresholds, o-scheduler sends a signal (452) to the c-scheduler. Once received, the c-scheduler will properly adjust the scheduling policy, and notify (451) i-scheduler to make associated scheduling changes. For example, one egress port is not able to accept one type of incoming traffic due to some reason, the i-scheduler can temporally block the type of traffic in the IQ, but other types of traffic destined to the same port can still participate to be scheduled by the c-scheduler. In contrast to practical implemented architectures (see references), the fundamental difference in our design is that the priority processing is partitioned into two levels: CoS/ToS at ingress and QoS at egress, such that the matching scheduling on both per port basis and on per COS/QoS basis. As a result, the throughput and QoS can be simultaneously satisfied. Furthermore, the congestion control is effectively distributed in both input (IQ) and output (OQ), so that the ratio of packets/cells dropping possibly occurred at IQ is minimized. It is worth to point out that the packets/cells dropping here is said to be deterministic since dropped packets/cells according to the signaling feedback can really relieve or eliminate the congestion with minimum packets/cells dropping ratio. In contrast, some deployed approaches (e.g., random-early-detection, weighted-random-early-detection) is said to be non-deterministic since packets/cells dropping according to statistical information may not alleviate a congestion (i.e., the congestion still exists even some packets/cells were dropped).

Accordingly, another key entity in our design is the centralized scheduler in which two major operational components are contained: universal scheduling used for uniform traffic, and self-adaptive scheduling used for non-uniform traffic. Switching between the two entities is dynamic and automatic based on the traffic load status. A set of provisional policies is used to determine the traffic status.

When compared with prior art technologies, the present invention simultaneously offers much lower complexity, 100% maximum throughput and supporting differentiated QoS. None of the existing industrially viable algorithms has comparable performance, despite the fact that some academic research results showed possible significant performance improvements. Table 1 as listed below summarizes the performance comparisons between the algorithms of the prior art as that discussed in the Background of the Invention above and the present invention.

TABLE 1
Performance Summary of Existing Algorithms and
the Present Invention

| | Complexity | | |
|---|---|---|---|
| | (with physical | Maximum | Differentiated |
| Algorithm | capacity) | Throughput | QoS |
| TSA | O(N²⁵) | 100% | Not |
| | | | Supported |
| MM | O(N²) | 50% | Not |
| | | | Supported |
| SM | Ω(N²) or O(N²) | 50% | Supported |
| Present | C (for uniform | 100% | Supported |
| Invention | traffic) | | |
| | O(N²) (for non | | |
| | uniform traffic) | | |

Where C is constant.

According to above descriptions and comparisons, a first advantage of the present invention is that the distributed queuing-buffering architecture, which enables prioritized traffic processing all the way from ingress to egress. Also, the centralized scheduling is independent of the number of ports so that maximizes the switching salability (while the iSLIP-scheduling algorithm is restricted up to 32 ports). Consequently, line-rate throughput can be achieved and various QoS′ can be satisfied. A second advantage of the present invention is that the centralized scheduling features are designated for handling both uniform and non-uniform traffic flows. Thus, the resource (e.g., memory, bandwidth) can be effectively utilized such that makes the device always running in an optimal status. In addition, parallel and distributed operations are comprehensively combined in the algorithms to reduce the time and space complexities such that the algorithms are easily implemented in ASIC-based hardware. A third advantage of the present invention is that congestion can be effectively controlled and reduced without resorting to packet losing for that traffic with “best effort” service.

According to above descriptions and FIGS. 1 to 4, this invention discloses a network switching router for forwarding messages received from a plurality of ingress ports to a plurality of egress ports across a forwarding engine. The switching router includes a plurality of ingress line-cards each supports several of the plurality of input ports and a plurality of egress line-cards each supports several of the plurality of output ports. In these line-cards, different message queuing processes are arranged according to different levels of message processes designated to the ingress and egress line-cards for forwarding messages controlled by distributed schedulers reside at the ingress and egress line-cards and the switching fabric for centralized scheduling to forward message depending on an aggregated traffic condition and known quality of service attributes. In a preferred embodiment, each of traffic flows comes with an attribute of type of service (ToS) or class of service (CoS). And, each of the ToS′ and CoS′ maps to one of three service-level--categories (SLCs) with attributes of quality-of-service (QoS). These categories are delay/jitters and loss, loss only, non-specified delay and loss (i.e., best effort). The incoming traffic flow is grouped and processed on the SLCs in priorities. In a preferred embodiment, the incoming packets before enqueuing at ingress line-cars are segmented with protocol and payload agnostic into fixed length frames. And, the outgoing frames before dequeuing at egress line-cards are re-assembled into original packets. The frames are inter-exchangeable to message in this claim. In a preferred embodiment, each of the ingress line-cards includes a type of service (ToS) and/or class of service (CoS) message enqueuing/dequeuing means for grouped messages received from the input ports on each line card according to ToS/CoS priorities. In another preferred embodiment, each of the egress line-cards includes a quality of service (QoS) message enqueuing/dequeuing means for grouped messages received from switching fabric on each egress line card according to QoS requirements. In another preferred embodiment, the distributed schedulers monitoring the ingress line-cards for coordinating with the queuing processes on the ingress line-cards for arbitrating and dispatching the messages. In another preferred embodiment, the distributed schedulers monitoring the egress line-cards for coordinating with the queuing processes on the egress line-cards for arbitrating and dispatching the messages. In another preferred embodiment, one of the centralized schedulers monitoring the ingress and egress line-cards for coordinating with the scheduling processes on the ingress and egress line-cards and the switching fabric for arbitrating and forwarding the messages.

This invention further discloses a message-forwarding device for a communication network. The message-forwarding device includes a plurality of ingress line cards each supporting a plurality of ingress ports, the ingress line cards connected to a switching fabric and the switching fabric connected to a plurality of egress line cards each supporting a plurality of egress ports. One of the message forwarding from an input line-card to an output line-card across the switching fabric comprising queuing processes, distributed scheduling processes and centralized scheduling processes wherein the centralized scheduler coordinating with the distributed schedulers for carrying out message dispatching from the ingress ports to the egress ports. Furthermore, the communication network could be metropolitan based or wide-area based. In a preferred embodiment, eacgh of the ingress line-cards includes virtual output port queues (VOPQs) for message queuing arranged according to the three SLCs in priorities and destined egress ports for all messages received by each of the ingress ports. Each of the ingress line-cads includes virtual output card queues (VOCQs) for message queuing arranged according to destined egress cards for all messages received by each of the ingress ports. In another preferred embodiment, each of the egress line-cards includes virtual input card queues (VICQs) for message queuing corresponding to an order of message queuing of the VOCQ in each of the ingress line cards. Wherein each VICQ manages queues on the three SLCs in priorities for destined egress ports. And, each of the egress line-cards includes output queues (OQs) for message queuing corresponding to each of the egress ports. Wherein each OQs is identical to traffic with a particular QoS parameters or type/class of service (T/CoS). In a preferred embodiment, the distributed scheduler in each of the ingress line-cards implemented with the service-level-categories (SLCs) means for dispatching message according to the priorities and fairness. The distributed scheduler in each of the egress line-cards is implemented with a quality of service (QoS) arbitrating means for dispatching message according to the priorities of the SLCs and fairness. In another preferred embodiment, the centralized scheduler coordinating with status of the VOCQ to perform a self-adaptive scheduling for accommodating non-uniform and uniform traffic.

In essence, this invention discloses a message forwarding device for a communication network having a plurality of ingress line-cards connected to a switching fabric and a plurality of egress line-cards. The message-forwarding device further includes a multiple-stage message queuing means for queuing messages received from the ingress line cards over a plurality of stages. In a preferred embodiment, the multiple-stage message queuing means further comprising 3-group queuing means for queuing the messages received from each of the ingress ports according to a CoS/ToS priority. In another preferred embodiment, the multiple-stage message queuing means further comprising virtual output/input queuing means for queuing fix-length messages by packetizing the packets received from each of the ingress ports an sent from each of the egress ports. In another preferred embodiment, the message-forwarding device is protocol-agnostic in support of handling a plurality of protocols. In another preferred embodiment, the message forwarding device is payload agnostic in support of a plurality of variable length packets up to 64 k bytes.

A message-forwarding device is disclosed in this invention for a communication network having centralized scheduling processes. The centralized scheduling processes are self-adaptive for both uniform and non-uniform traffic from the ingress ports to the egress ports. In a preferred embodiment, the centralized scheduling process performs continuously, one replaces previous one, during a time slot in which S messages are forwarded across a deterministic trunk in the switching fabric based on the arbitrating decision. And, the centralized scheduling processes comprising determined-trunking and asynchronous-round-robin provide an optimal maximal traffic flow matching between ingress ports and egress ports with taking care of QoS and fairness. In another preferred embodiment, the centralized scheduling processes run simultaneously on two sets of the VOCQs dynamically partitioned based on a 0-1 status matrix that is updated in real-time manners and operated in parallel according to provisional rules.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention. Those approaches and mechanisms in the art will appreciate variations of the above-described embodiments that fall within the scope of the invention. As a result, the invention is not limited to the specific examples and illustrations discussed above, but only the following claims and their equivalents.

We claim:

1. A network switching router for forwarding a plurality of messages received from a plurality of ingress ports to a plurality of egress ports across a forwarding engine comprising:
a plurality of ingress line-cards each supports several of said plurality of input ports and a plurality of egress line-cards each supports several of said plurality of output ports wherein several message queuing processes are arranged according to different levels of message processes designated to said ingress and egress line-cards for forwarding said messages controlled by distributed schedulers over said ingress and egress line-cards and said switching fabric for centralized scheduling for forwarding said messages depending on an aggregated traffic condition and a quality of service (QoS) attributes for each said messages.

2 The network switching router of claim 1 wherein:
each of said ingress line-cards includes a types of service and/or class of service (ToS/CoS) message queuing/de-queuing means for grouping and queuing each of said messages received from said input ports on each line card according to a ToS/CoS priority.

3. The network switching router of claim 2 wherein:
said (ToS/CoS) message queuing/de-queuing means further includes a service level category (SLC) grouping means for grouping and queuing each of said messages received from said input ports on each line card according to a QoS attributes into three SLC categories of delay/jitters and loss, loss only, non-specified delay and loss for best effort transmission.

4. The network switching router of claim 1 wherein:
coming packets before enqueuing at ingress line-cars are segmented with protocol and payload agnostic into fixed length frames.
outgoing frames before dequeuing at egress line-cards are re-assembled into original packets.
said frames are inter-exchangeable to message in this claim.

3 The network packet switch-router of claim 1 wherein:
each of said egress line-cards includes a quality of service (QoS) message queuing means for queuing messages received from switching fabric on each egress line card according to a QoS priority.

4 The network packet switch-router of claim 1 wherein:
one of said centralized schedulers monitoring said ingress line-cards for coordinating with said queuing processes on said ingress line-cards for scheduling and forwarding said messages.

5 The network packet switching router of claim 1 wherein:
each of said egress line-cards includes a quality of service (QoS) message enqueuing/dequeuing means for grouped messages received from switching fabric on each egress line card according to QoS requirements. 6. The network packet switching router of claim 1 wherein:
said distributed schedulers monitoring said ingress line-cards for coordinating with said queuing processes on said ingress line-cards for arbitrating and dispatching said messages.

7 The network packet switching router of claim 1 wherein:
said distributed schedulers monitoring said egress line-cards for coordinating with said queuing processes on said egress line-cards for arbitrating and dispatching said messages.

8 The network packet switching router of claim 1 wherein:
one of said centralized schedulers monitoring said ingress and egress line-cards for coordinating with said scheduling processes on said ingress and egress line-cards and said switching fabric for arbitrating and forwarding said messages.

9 A message forwarding device for a communication network comprising:
a plurality of ingress line cards each supporting a plurality of ingress ports, said ingress line cards connected to a switching fabric and said switching fabric connected to a plurality of egress line cards each supporting a plurality of egress ports; and
of said message forwarding from an input line-card to an output line-card across said switching fabric comprising queuing processes, distributed scheduling processes and centralized scheduling processes wherein said centralized scheduler coordinating with said distributed schedulers for carrying out message dispatching from said ingress ports to said egress ports.
wherein the communication network could be metropolitan based or wide-area based.

10 The message forwarding device of claim 9 wherein:
each of said ingress line-cards includes virtual output port queues (VOPQs) for message queuing arranged according to said three SLCs in priorities and destined egress ports for all messages received by each of said ingress ports.
each of said ingress line-cads includes virtual output card queues (VOCQs) for message queuing arranged according to destined egress cards for all messages received by each of said ingress ports.

11 The message forwarding device of claim 9 wherein:
each of said egress line-cards includes virtual input card queues (VICQs) for message queuing corresponding to an order of message queuing of said VOCQ in each of said ingress line cards. Wherein each VICQ manages queues on said three SLCs in priorities for destined egress ports.
each of said egress line-cards includes output queues (OQs) for message queuing corresponding to each of said egress ports. Wherein each OQs is identical to traffic with a particular QoS parameters or type/class of service (T/CoS).

12 The message forwarding device of claim 9 wherein:
said distributed scheduler in each of said ingress line-cards implemented with said service-level-categories (SLCs) means for dispatching message according to the priorities and fairness.
said distributed scheduler in each of said egress line-cards implemented with a quality of service (QoS) arbitrating means for dispatching message according to the priorities of said SLCs and fairness.

13 The message forwarding device of claim 9 wherein:
said centralized scheduler coordinating with status of said VOCQ to perform a self-adaptive scheduling for accommodating non-uniform and uniform traffic.

14. A message forwarding device for a communication network having a plurality of ingress line-cards connected to a switching fabric and a plurality of egress line-cards, said message forwarding device further comprising:
a multiple-stage message queuing means for queuing messages received from said ingress line cards over a plurality of stages.

15 The message forwarding device of claim 14 wherein:
said multiple-stage message queuing means further comprising 3-group queuing means for queuing said messages received from each of said ingress ports according to a CoS/ToS priority.

16. The message forwarding device of claim 14 wherein:
said multiple-stage message queuing means further comprising virtual output/input queuing means for queuing fix-length messages by packetizing said packets received from each of said ingress ports an sent from each of said egress ports.

17. The message forwarding device of claim 14 wherein:
said message forwarding device is protocol agnostic in support of handling a plurality of protocols.
said message forwarding device is payload agnostic in support of a plurality of variable length packets up to 64 k bytes.

18. A message forwarding device for a communication network having centralized scheduling processes wherein:
said centralized scheduling processes is self-adaptive for both uniform and non-uniform traffic from said ingress ports to sa id egress ports.

19. The message forwarding device of claim 18 wherein:
said centralized scheduling process performs continuously, one replaces previous one, during a time slot in which S messages are forwarded across a deterministic trunk in the switching fabric based on the arbitrating decision.
said centralized scheduling processes comprising determined-trunking and asynchronous-round-robin provide an optimal maximal traffic flow matching between ingress ports and egress ports with taking care of QoS and fairness.

20. The message forwarding device of claim 19 wherein:
said centralized scheduling processes run simultaneously on two sets of said VOCQs dynamically partitioned based on a 0-1 status matrix that is updated in real-time manners and operated in parallel according to provisional rules.
